(19) United States
(12) Patent Application Publication
(10) Pub. No.: US 2026/0227423 A1
(43) Pub. Date: Aug. 6, 2026

(54) COMPOSITE SENSOR AND METHOD OF MANUFACTURING COMPOSITE SENSOR

(71) Applicant: Murata Manufacturing Co., Ltd., Nagaokakyo-shi (JP)

(72) Inventors: Masakazu FUKUMITSU, Nagaokakyo-shi (JP); Takeya Matsumura, Nagaokakyo-shi (JP)

(21) Appl. No.: 19/636,293

(22) Filed: Apr. 1, 2026

Related U.S. Application Data
(63) Continuation of application No. PCT/JP2024/035834, filed on Oct. 7, 2024.

(30) Foreign Application Priority Data
Dec. 6, 2023 (JP) 2023-206032

(51) Int. Cl. G01P 1/02; G01P 1/00

(52) U.S. Cl. CPC G01P 1/023; G01P 1/003; G01P 1/026

(57) ABSTRACT

A composite sensor is provided that includes a first substrate, a second substrate opposing the first substrate with a gap interposed therebetween, a first sealing frame that seals a first space between the first and second substrates, and a second sealing frame that seals a second space between the first and second substrate. In the composite sensor, an acceleration sensor is disposed in one of the first and second spaces and an angular velocity sensor is disposed in the other of the first and second spaces. Moreover, a degree of vacuum of the first space is different from that of the second space, and the first and second sealing frames are made of a eutectic alloy.

### CROSS REFERENCE TO RELATED APPLICATIONS

This application is a continuation of International Application No. PCT/JP2024/035834, filed October 07, 2024, which claims priority to Japanese Patent Application No. 2023-206032, filed December 06, 2023, the entire contents of each of which are hereby incorporated by reference in their entirety.

### TECHNICAL FIELD

The present disclosure relates to a composite sensor and a method of manufacturing the composite sensor.

### BACKGROUND

In a composite sensor equipped with an acceleration sensor and an angular velocity sensor, the acceleration sensor and the angular velocity sensor require different degrees of vacuum. Accordingly, the acceleration sensor and the angular velocity sensor are manufactured, for example, in separate processes and are mounted in the composite sensor thereafter. In the case of mounting the multiple sensors as above, an axial deviation may occur between these sensors, which may pose an obstacle in producing a high-performance composite sensor. To overcome this challenge, a new manufacturing method has been studied to form separate spaces with different degrees of vacuum in a single substrate and to seal the acceleration sensor and the angular velocity sensor in these spaces.

For example, Japanese Unexamined Patent Application Publication No. 2016-33464 discloses a method of manufacturing a physical-quantity sensor. The method disclosed therein includes a providing step of providing a support substrate in which a first sensor element and a second sensor element are formed and also providing a sealing substrate having a first cavity and a second cavity formed at a surface thereof that faces the support substrate and also having a through hole communicating with the first cavity; a bonding step of bonding the sealing substrate to the support substrate in such a manner that the first cavity accommodates the first sensor element and the second cavity accommodates the second sensor element; and a sealing step of sealing the first cavity by filling the through hole with a sealing material of which a melting point is lower than melting points or softening points of the support substrate and the sealing substrate.

International Publication No. 2013/080238 discloses another example of method of manufacturing a composite sensor. The method disclosed therein includes disposing a movable body of an acceleration sensor and a vibrating body of an angular velocity sensor on a single sensor wafer with the movable body and the vibrating body being separated from each other by a wall; forming a cap wafer having gaps corresponding to the respective sensors; and forming a through hole and a bump in a sensor sealing portion. The method also includes a first sealing step in which the acceleration sensor is sealed at atmospheric pressure by using anodic bonding and in which an internal pressure of the angular velocity sensor is adjusted through the through hole and an air passage formed by the bump. The method also includes a second sealing step of vacuum-sealing the angular velocity sensor, in which the bump is deformed by applying a load in a high-temperature atmosphere and the sensor wafer and the cap wafer are anodic-bonded by bringing these wafers into contact with each other in a vacuum atmosphere.

According to the method of manufacturing the physical-quantity sensor of Japanese Unexamined Patent Application Publication No. 2016-33464, the method requires the steps of forming the through hole, disposing the sealing material, and melting the sealing material. In other words, the number of steps increases in the above manufacturing process, which may lead to, for example, increases in the manufacturing cost, in the lead time, and in the number of defective products. Moreover, there is a concern of leakage not only in the bonding portion between the support substrate and the sealing substrate but also in the through hole that is sealed by the sealing material, which may cause the defective sealing and deteriorate the reliability of the product.

Moreover, according to the method of manufacturing the composite sensor of International Publication No. 2013/080238, the manufacturing process becomes more complicated because it requires forming the through hole in the sensor wafer and forming the bump on the bonding surface of the cap wafer that needs to be mirror-polished to enable the anodic bonding. The risk of leakage increases in the vicinity of the deformed bump, which in turn may cause the defective sealing and deteriorate the reliability of the product.

### SUMMARY OF THE INVENTION

In view of the above circumstances, it is an object of the present disclosure to provide a reliable composite sensor of which the manufacturing process is less complicated.

According to an exemplary aspect of the present disclosure, a composite sensor is provided that includes a first substrate, a second substrate that opposes the first substrate with a gap interposed therebetween, a first sealing frame sealing a first space between the first substrate and the second substrate, and a second sealing frame sealing a second space between the first substrate and the second substrate. In the composite sensor, an acceleration sensor is disposed in the first space (or the second space) and an angular velocity sensor is disposed in the second space (or the first space). Moreover, a degree of vacuum of the first space is different from that of the second space. The first sealing frame and the second sealing frame are made of a eutectic alloy.

According to another exemplary aspect of the present disclosure, a method of manufacturing a composite sensor is provided that includes providing a first substrate and providing a second substrate that opposes the first substrate with a gap interposed therebetween; forming a first sealing frame to seal a first space between the first substrate and the second substrate; and forming a second sealing frame to seal a second space between the first substrate and the second substrate. In the method of manufacturing the composite sensor, an acceleration sensor is formed in the first space (or the second space) and an angular velocity sensor is formed in the second space (or the first space). Moreover, a degree of vacuum of the first space is different from a degree of vacuum of the second space. The first sealing frame and the second sealing frame are made of a eutectic alloy.

The exemplary aspects of the present disclosure provide a reliable composite sensor of which the manufacturing process is less complicated. A method of manufacturing the composite sensor is also provided.

### BRIEF DESCRIPTION OF DRAWINGS

FIG. 1 is a cross-sectional view illustrating a composite sensor according to a first exemplary embodiment.

FIG. 2 is a plan view illustrating the composite sensor of the first exemplary embodiment.

FIG. 3 is a flowchart illustrating a method of manufacturing the composite sensor of the first exemplary embodiment.

FIG. 4 is a cross-sectional view illustrating a step of manufacturing the composite sensor of the first exemplary embodiment.

FIG. 5 is a cross-sectional view illustrating another step of manufacturing the composite sensor of the first exemplary embodiment.

FIG. 6 is a cross-sectional view illustrating another step of manufacturing the composite sensor of the first exemplary embodiment.

FIG. 7 is a cross-sectional view illustrating a composite sensor according to a second exemplary embodiment.

FIG. 8 is a flowchart illustrating a method of manufacturing the composite sensor of the second exemplary embodiment.

FIG. 9 is a cross-sectional view illustrating a step of manufacturing the composite sensor of the second exemplary embodiment.

FIG. 10 is a cross-sectional view illustrating another step of manufacturing the composite sensor of the second exemplary embodiment.

FIG. 11 is a cross-sectional view illustrating another step of manufacturing the composite sensor of the second exemplary embodiment.

FIG. 12 is a cross-sectional view illustrating a composite sensor according to a third exemplary embodiment.

FIG. 13 is a cross-sectional view illustrating a step of manufacturing the composite sensor of the third exemplary embodiment.

FIG. 14 is a cross-sectional view illustrating another step of manufacturing the composite sensor of the third exemplary embodiment.

FIG. 15 is a cross-sectional view illustrating another step of manufacturing the composite sensor of the third exemplary embodiment.

FIG. 16 is a cross-sectional view illustrating a composite sensor according to a fourth exemplary embodiment.

FIG. 17 is a cross-sectional view illustrating a step of manufacturing the composite sensor of the fourth exemplary embodiment.

FIG. 18 is a plan view illustrating a composite sensor according to a fifth exemplary embodiment.

FIG. 19 is a plan view illustrating a composite sensor according to a sixth exemplary embodiment.

### DETAILED DESCRIPTION OF EMBODIMENTS

Exemplary embodiments of the present disclosure will be described with reference to the drawings. The drawings for the embodiments are illustrative, and the dimensions and shapes of elements are schematic. The technical scope of the present disclosure should not be interpreted as being limited to the embodiments.

### First Exemplary Embodiment

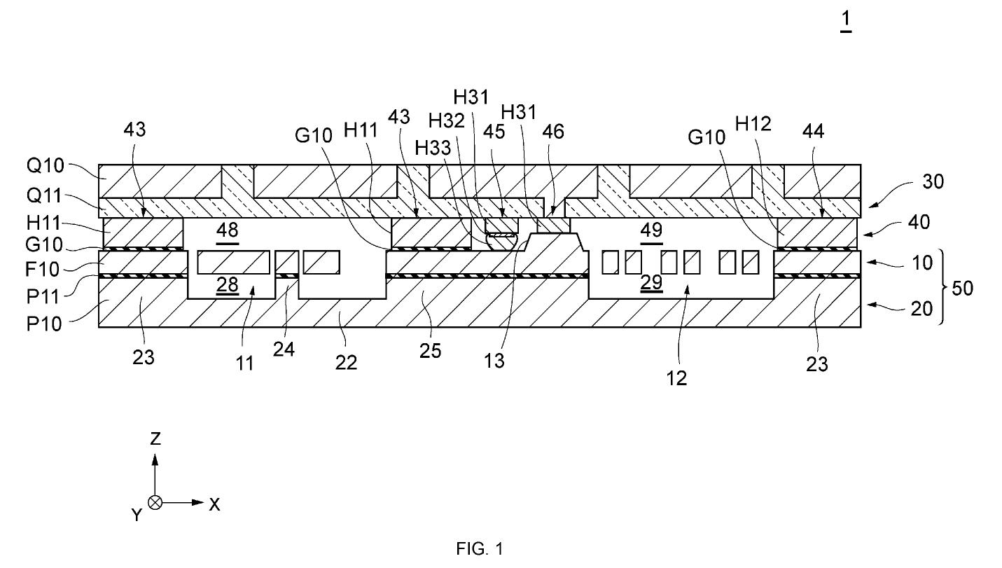

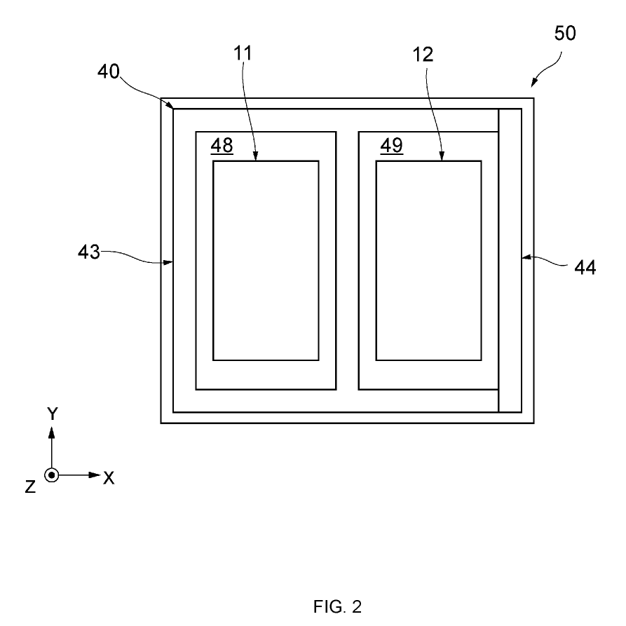

To begin with, the structure of a composite sensor 1 according to a first exemplary embodiment is described with reference to FIGS. 1 and 2. FIG. 1 is a cross-sectional view illustrating the composite sensor of the first embodiment. FIG. 2 is a plan view illustrating the composite sensor of the first embodiment.

The following describes elements of the composite sensor 1. In general, an orthogonal coordinate system consisting of an X-axis, a Y-axis, and a Z-axis may be indicated in the drawings for convenience in order to clarify the mutual relationship among the drawings and to help understand the positional relationship of each element. Directions parallel to the X-axis, the Y-axis, and the Z-axis are referred to as the X-axis direction, the Y-axis direction, and the Z-axis direction, respectively. For purposes of this disclosure, a plane defined by the X-axis and the Y-axis is the "XY plane". It is noted that as a matter of convenience, a side in the positive Z-axis direction (e.g., in the direction of the arrow pointing) indicates the upper side of the composite sensor 1, and a side in the negative Z-axis direction (e.g., in the direction opposite to the arrow-pointing direction) indicates the lower side of the composite sensor 1 although this does not mean the standard orientation of the composite sensor 1.

As shown, the composite sensor 1 includes a device layer 10, a lower cover 20, an upper cover 30, and a bonding layer 40. The lower cover 20, the device layer 10, the bonding layer 40, and the upper cover 30 are layered in this order in the Z-axis direction. The Z-axis direction in which the lower cover 20, the device layer 10, the bonding layer 40, and the upper cover 30 are layered is hereinafter referred to as the “thickness direction”. The device layer 10 and the lower cover 20 are bonded to form a MEMS substrate 50. The bonding layer 40 bonds the upper cover 30 to the device layer 10 of the MEMS substrate 50. In other words, the upper cover 30 is bonded to the lower cover 20 with the device layer 10 and the bonding layer 40 being interposed therebetween. The lower cover 20 and the upper cover 30 oppose each other with the device layer 10 and the bonding layer 40 being interposed therebetween in the thickness direction. The lower cover 20, the bonding layer 40, and the upper cover 30 form a package structure that defines an inside space in which the moving elements of the device layer 10 can move. According to the exemplary aspect, the MEMS substrate 50 corresponds to an example of a first substrate, and the upper cover 30 corresponds an example of a second substrate.

In an exemplary aspect, when the device layer 10 and the lower cover 20 are described using the terminology of the MEMS substrate 50, a silicon substrate P10 of the lower cover 20 corresponds to a support substrate (i.e., handle layer) of an SOI substrate, a silicon oxide film P11 of the lower cover 20 corresponds to a BOX layer of the SOI substrate, and a silicon substrate F10 of the device layer 10 corresponds to a device layer of the SOI substrate. The silicon substrate P10, the silicon oxide film P11, and the silicon substrate F10 will be described later.

The device layer 10 is formed of the silicon substrate F10. In an exemplary aspect, the silicon substrate F10 is made of single-crystal silicon. In an exemplary aspect, the silicon substrate F10 is made of p-silicon (Si) semiconductor. The silicon substrate F10 may contain boron (B) as a p-dopant. In an exemplary aspect, the resistance of the silicon (Si) used for the silicon substrate F10 is approximately 10 mΩ∙cm. It is noted that the material of the device layer 10 is not limited to the silicon semiconductor insofar as an acceleration sensor and an angular velocity sensor can be formed in the device layer 10.

Moreover, the device layer 10 includes an acceleration sensor 11, an angular velocity sensor 12, and a projection 13. The acceleration sensor 11, the angular velocity sensor 12, and the projection 13 are formed by patterning and removing some portions of the silicon substrate F10. In an exemplary aspect, an isotropic wet etching using HF and HNO₃ may be used to perform the above removal processing to form the projection 13. In an exemplary aspect, a dry etching of so-called DRIE (deep reactive ion etching) may be used for the removal processing to form the acceleration sensor 11 and the angular velocity sensor 12. The DRIE is a type of sputter etching in which a target is irradiated with ions accelerated in an electric field. It is noted that the removal processing for forming the projection 13 and for forming the acceleration sensor 11 and the angular velocity sensor 12 are not limited to the above. Various other etching methods may be adopted, such as a crystal anisotropic wet etching using an alkaline etchant, an isotropic dry etching using a reactive gas or plasma, a vertical anisotropic dry etching using reactive ions, and a laser etching, as would be appreciated to one skilled in the art.

The device layer 10 and the lower cover 20 define movement spaces 28 and 29, while the device layer 10 and the upper cover 30 define movement spaces 48 and 49. The movement space 28 and the movement space 29 are separated from each other, and the movement space 48 and the movement space 49 are also separated from each other. The movement space 28 is connected to the movement space 48, and the movement space 29 is connected to the movement space 49. The movement spaces 28 and 48 are provided for the acceleration sensor 11, and the movement spaces 29 and 49 are provided for the angular velocity sensor 12. For purposes of this disclosure and in the exemplary embodiment, the movement spaces 28 and 48 correspond to an example of a first space, and the movement spaces 29 and 49 correspond to an example of a second space.

The acceleration sensor 11 is configured to detect accelerations in the X-axis direction, Y-axis direction, and Z-axis direction by detecting a change in capacitance of a moving element formed in the silicon substrate F10. It is desirable that the acceleration sensor 11 receives a strong damping effect from a seal gas in order to suppress the free vibration of the moving element. Accordingly, the movement spaces 28 and 48 in which the acceleration sensor 11 is accommodated are sealed with a gas at a low vacuum. The pressure inside the movement spaces 28 and 48 is desirably approximately 0.1 atm or more and 10 atm or less, and more desirably approximately 0.5 atm or more and 5 atm or less. For example, the pressure is set to about 1 atm. When the pressure inside the movement spaces 28 and 48 is set to 0.1 atm or more or desirably 0.5 atm or more, the acceleration sensor 11 can receive the damping effect sufficiently, which improves the detection sensitivity of acceleration. When the pressure is set to 10 atm or less or desirably 5 atm or less, the acceleration sensor 11 can be prevented from receiving an excess amount of the damping effect, thereby suppressing the deterioration of the detection sensitivity of acceleration.

Moreover, the angular velocity sensor 12 is configured to detect angular velocities about rotation axes extending in the X-axis direction, Y-axis direction, and Z-axis direction by detecting a change in capacitance of a moving element formed in the silicon substrate F10. In order to increase the displacement of the moving element and to improve the sensitivity, it is desirable that the angular velocity sensor 12 be more resistant to receive a damping effect from a seal gas. Accordingly, the movement spaces 29 and 49 in which the angular velocity sensor 12 is accommodated are sealed with a gas at a high vacuum of which the degree of vacuum is higher than that of the movement spaces 28 and 48. The pressure inside the movement spaces 29 and 49 is desirably approximately 1 Pa or more and 100 Pa or less, and more desirably approximately 5 Pa or more and 50 Pa or less. For example, the pressure is set to about 10 Pa. When the pressure inside the movement spaces 29 and 49 is set to 1 Pa or more or desirably 5 Pa or more, an increase in the time and cost required for the production can be suppressed. By setting the pressure to 100 Pa or less or desirably 50 Pa or less in the movement spaces 29 and 49, the damping effect that the angular velocity sensor 12 receives can be suppressed sufficiently, which improves the detection sensitivity of angular velocity.

The movement spaces 28 and 48, which correspond to the first space, and the movement spaces 29 and 49, which correspond to the second space, are both filled with an inert gas. Examples of the inert gas include nitrogen, argon, helium, or neon.

As further shown, the projection 13 projects toward the upper cover 30. The projection 13 comes into contact with a contact portion 46 (to be described later), thereby electrically connecting the upper cover 30 and the MEMS substrate 50.

The lower cover 20 is formed of the silicon substrate P10 and the silicon oxide film P11. The silicon oxide film P11 is formed on the upper surface of the lower cover 20, the upper surface being bonded to the device layer 10. The silicon substrate P10 of the lower cover 20 is bonded to the silicon substrate F10 of the device layer 10 with the silicon oxide film P11 being interposed therebetween.

The lower cover 20 includes a bottom plate 22, side walls 23, a support 24, and an inside wall 25. The movement spaces 28 and 29 are formed in the lower cover 20 at the surface opposing the acceleration sensor 11 and the angular velocity sensor 12 of the device layer 10. The movement spaces 28 and 29 are surrounded by the bottom plate 22 and the side walls 23. The inside wall 25 separates the movement space 28 from the movement space 29. The movement space 28 is a cuboid-shaped cavity that opens toward the acceleration sensor 11. In an exemplary aspect, the movement space 29 is a cuboid-shaped cavity that opens toward the angular velocity sensor 12.

The bottom plate 22 is positioned so as to be spaced from the acceleration sensor 11 and the angular velocity sensor 12 in the thickness direction. The bottom plate 22 is a plate-like portion having principal surfaces extending along the XY plane. The bottom plate 22 is formed of the silicon substrate P10.

As further shown, the side walls 23 extend from the peripheral portions of the bottom plate 22 toward the upper cover 30. As the lower cover 20 is viewed in plan, the side walls 23 are frame-like portions that surround the acceleration sensor 11 and the angular velocity sensor 12. The base-end portions of the side walls 23, which are portions connected to the bottom plate 22, are formed of the silicon substrate P10. The silicon oxide films P11 are formed on the distal-end portions of the side walls 23, and the side walls 23 are bonded to the silicon substrate F10 of the device layer 10 with the silicon oxide film P11 interposed therebetween.

The support 24 extends from the bottom plate 22 toward the device layer 10. The base-end portion of the support 24, which is a portion connected to the bottom plate 22, is formed of the silicon substrate P10. The silicon oxide film P11 is formed on the distal-end portion of the support 24, and the support 24 is bonded to the silicon substrate F10 of the acceleration sensor 11 with the silicon oxide film P11 interposed therebetween.

The inside wall 25 extends from a central portion of the bottom plate 22 toward the upper cover 30. As the lower cover 20 is viewed in plan, the inside wall 25 is positioned between the acceleration sensor 11 and the angular velocity sensor 12. The base-end portion of the inside wall 25, which is a portion connected to the bottom plate 22, is formed of the silicon substrate P10. The silicon oxide film P11 is formed on the distal-end portion of the inside wall 25, and the inside wall 25 is bonded to the silicon substrate F10 of the device layer 10 with the silicon oxide film P11 interposed therebetween.

In an exemplary aspect, the upper cover 30 is a tabular plate. For example, the upper cover 30 is formed of a silicon substrate Q10 and a glass substrate Q11. For example, the silicon substrate Q10 is formed of p-silicon (Si) semiconductor. In an exemplary aspect, the resistance of the silicon (Si) used for the silicon substrate Q10 is approximately 10 mΩ∙cm. The glass substrate Q11 is made of a silicate glass having a silicon oxide (for example, SiO₂) as a main component. The main component is a component of which the content is 50 mass% or more among all the components of the glass. In an exemplary aspect, the glass substrate Q11 is made of a non-alkali glass. In the case of the glass substrate Q11 of the upper cover 30 being bonded to the silicon substrate F10 of the device layer 10 using anodic bonding, the glass substrate Q11 needs to be an alkali glass. In the present embodiment, however, the glass substrate Q11 is bonded to the silicon substrate F10 using a eutectic alloy H10 (to be described later), and accordingly the glass substrate Q11 may be made of a non-alkali glass. When the glass substrate Q11 is made of the non-alkali glass, the migration of alkali ions does not occur to cause the product characteristics to change, which improves the reliability of the composite sensor 1.

Moreover, the glass substrate Q11 is formed substantially on the surface of the silicon substrate Q10 that faces toward the MEMS substrate 50. The silicon substrate Q10 includes multiple regions spaced from each other in directions parallel to the XY plane. The glass substrate Q11 is present between adjacent regions of the silicon substrate Q10 spaced from each other in the directions parallel to the XY plane. The glass substrate Q11 electrically isolates the regions of the silicon substrate Q10 from each other. The silicon substrate Q10 pierces through the glass substrate Q11 in the Z-axis direction at a position that superposes a contact portion 46, which will be described later.

In general, it is noted that the material of the upper cover 30 is not limited to those of the silicon substrate Q10 and the glass substrate Q11. The upper cover 30 may have a silicon oxide film in place of the glass substrate Q11 or may have the silicon oxide film in addition to the silicon substrate Q10 and the glass substrate Q11. The upper cover 30 may be formed of a compound semiconductor substrate, a glass substrate, a ceramic substrate, a resin substrate, or a combination of these. Moreover, a via electrode may be formed so as to pierce through the glass substrate Q11 at the position that superposes a contact portion 46 (to be described later). Such a via electrode can be formed, for example, by filling the through-hole with, for example, polycrystalline silicon (Poly-Si), copper (Cu), or gold (Au).

The bonding layer 40 includes sealing frames 43 and 44, a spacer portion 45 (also referred to as a “spacer”), and a contact portion 46.

As illustrated in FIG. 1, the sealing frames 43 and 44 bond the MEMS substrate 50 and the upper cover 30 together. The sealing frame 43 seals the movement space 48, and the sealing frame 44 seals the movement space 49. As illustrated in FIG. 2, the sealing frame 43 continuously surrounds the movement space 48, and the sealing frame 44 is provided as a part of a frame surrounding the movement space 49. The sealing frame 44 is connected to the sealing frame 43, and the movement space 49 is surrounded by the sealing frame 43 and the sealing frame 44. The sealing frame 43 corresponds to an example of a first sealing frame, and the sealing frame 44 corresponds to an example of a second sealing frame.

As illustrated in FIG. 1, the sealing frame 43 includes a silicon oxide film G10 and a eutectic alloy H11 that are laminated in the thickness direction, whereas the sealing frame 44 includes the silicon oxide film G10 and a eutectic alloy H12 that are laminated in the thickness direction. The eutectic alloy H11 is formed between the silicon oxide film G10 and the glass substrate Q11, and the eutectic alloy H12 is also formed between the silicon oxide film G10 and the glass substrate Q11. The silicon oxide film G10 is disposed between the silicon substrate F10 and the eutectic alloy H11 and also between the silicon substrate F10 and the eutectic alloy H12. The silicon oxide film G10 is formed on the surface of the silicon substrate F10 that faces the upper cover 30. The eutectic alloys H11 and H12 are formed on the surface of the glass substrate Q11 that faces the MEMS substrate 50. The silicon oxide film G10 prevents the components of the silicon substrate F10 from being mixed in the eutectic alloys H11 and H12.

According to the exemplary aspect, the eutectic alloys H11 and H12 can be made of an Al-Ge-Ti-based eutectic alloy that contains aluminum (Al), germanium (Ge), and titanium (Ti). Moreover, the composition of the eutectic alloy H11 is different from that of the eutectic alloy H12. In an exemplary aspect, the weight ratio of aluminum to the germanium (Al:Ge) contained in the eutectic alloy H11 is 1:1, whereas the weight ratio of aluminum to the germanium (Al:Ge) contained in the eutectic alloy H12 is 4:6.

It is noted that the eutectic alloys H11 and H12 are not limited to the Al-Ge-Ti-based eutectic alloy but may be, for example, an Al-Ge-based eutectic alloy, an Au-Sn-based eutectic alloy, or an Al-Si-based eutectic alloy. The weight ratio of the aluminum to germanium contained in the eutectic alloy H11 may be substantially the same as that in the eutectic alloy H12.

The spacer portion 45 includes an aluminum layer H31, a titanium layer H32, and another aluminum layer H33. The aluminum layer H31, the titanium layer H32, and the aluminum layer H33 are layered in this order in the Z-axis direction. The aluminum layer H31 is formed on the surface of the glass substrate Q11 of the upper cover 30, the surface facing the MEMS substrate 50. The titanium layer H32 is formed on the surface of the aluminum layer H31 that faces the MEMS substrate 50. The aluminum layer H33 is formed on the surface of the titanium layer H32 that faces the MEMS substrate 50. The aluminum layers H31 and H33 are made of aluminum (Al), and the titanium layer H32 is made of titanium (Ti).

The spacer portion 45 is configured to control the amount of gap between the MEMS substrate 50 and the upper cover 30. In particular, the spacer portion 45 protrudes from the upper cover 30 in the negative Z-axis direction and comes into contact with the silicon substrate F10 of the device layer 10. When the temperature is sufficiently lower than the melting point of aluminum, the spacer portion 45 maintains the gap between the upper cover 30 and the MEMS substrate 50 against the pressure applied in a direction in which the gap between the upper cover 30 and the MEMS substrate 50 becomes narrower. When the temperature is close to the melting point of aluminum, the spacer portion 45 deforms to narrow the gap due to the pressure applied in the direction in which the gap between the upper cover 30 and the MEMS substrate 50 becomes narrower.

The contact portion 46 includes the aluminum layer H31. The contact portion 46 protrudes from the upper cover 30 in the negative Z-axis direction and comes into contact with the projection 13 of the silicon substrate F10 of the device layer 10. The contact portion 46 electrically connects the projection 13 of the device layer 10 to the silicon substrate Q10 exposed at the surface of the upper cover 30 that faces the MEMS substrate 50. The contact portion 46 thereby electrically connects the acceleration sensor 11 and the angular velocity sensor 12 to outer electrodes of the composite sensor 1 (the illustration is omitted).

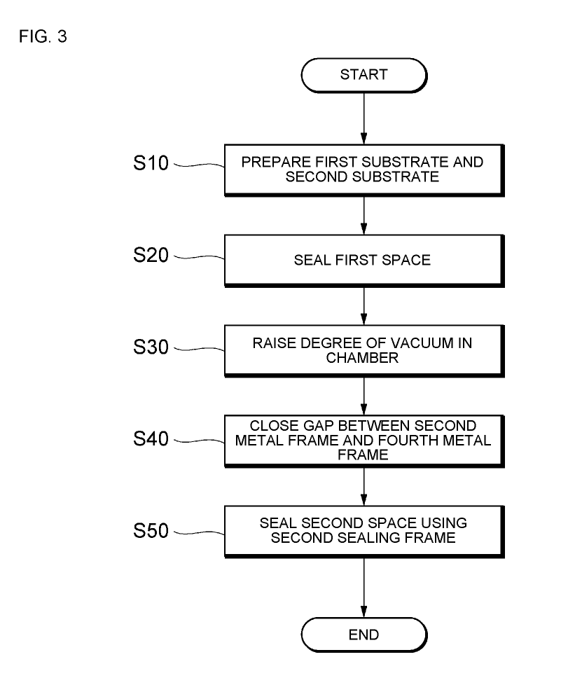

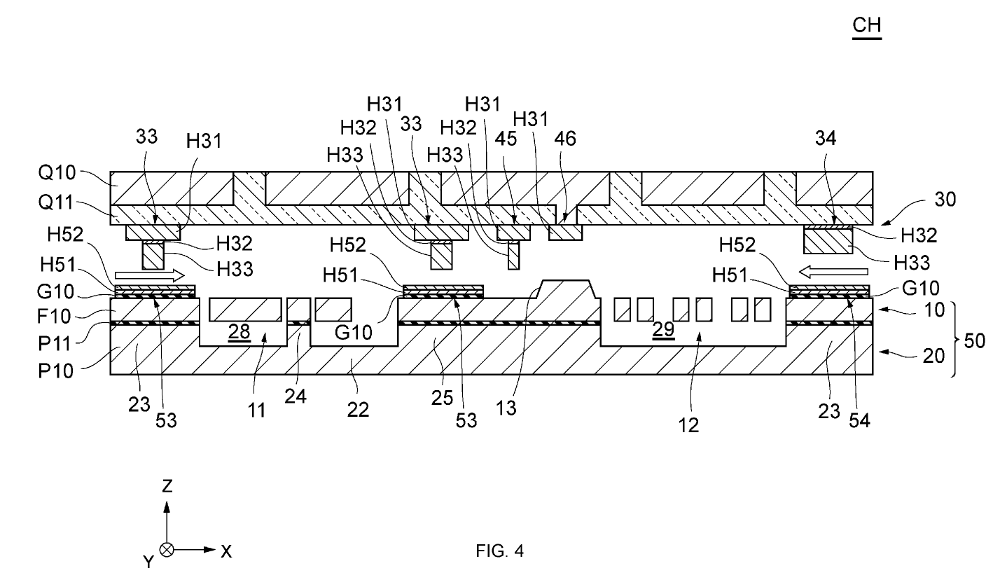

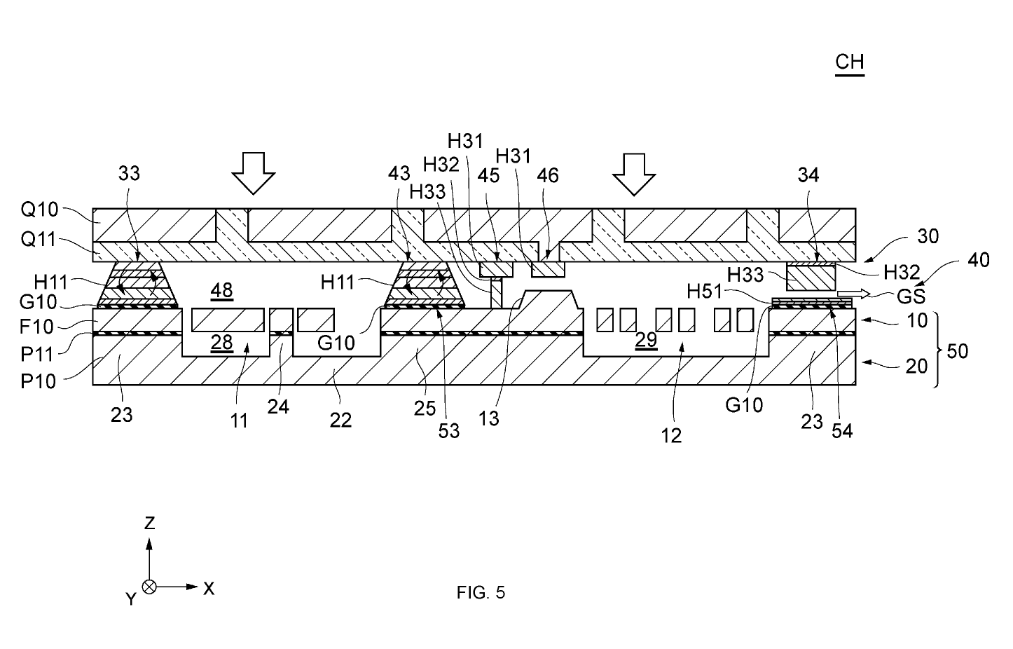

Next, a method of manufacturing the composite sensor 1 of the first exemplary embodiment will be described with reference to FIGS. 3 to 6. FIG. 3 is a flowchart illustrating a method of manufacturing the composite sensor of the first exemplary embodiment. FIGS. 4 to 6 are cross-sectional views illustrating steps of manufacturing the composite sensor of the first embodiment.

In the manufacture of the composite sensor 1, to begin with, a first substrate (i.e., the MEMS substrate 50) and a second substrate (i.e., the upper cover 30) are prepared (in step S10).

In preparing the MEMS substrate 50, the silicon substrate P10 is provided and one surface thereof is mirror-polished. The silicon oxide film P11 is formed on the mirror-polished surface of the silicon substrate P10. The movement spaces 28 and 29 are formed by partially removing the silicon oxide film P11 and an upper part of the silicon substrate P10 using dry etching or the like.

Next, the silicon substrate F10 is bonded to the lower cover 20. The silicon substrate F10 is provided and one surface thereof is mirror-polished. The mirror-polished surface of the silicon substrate F10 is brought into contact with the silicon oxide film P11 and heat-treated to directly bond the silicon substrate F10 and the silicon oxide film P11 together. Next, the projection 13 is formed at the silicon substrate F10 using wet etching. It is noted that the projection 13 may be formed before the direct bonding of the silicon substrate F10 and the silicon oxide film P11.

Next, the silicon substrate F10 is subjected to removal processing to form the device layer 10. More specifically, a photoresist is patterned on the upper surface of the silicon substrate F10, and the silicon substrate F10 is subjected to the removal processing using dry etching. The acceleration sensor 11 and the angular velocity sensor 12 are thereby formed as illustrated in FIG. 4.

Next, metal frames 53 and 54 are formed as illustrated in FIG. 4. According to an exemplary aspect, the metal frame 53 corresponds to an example of a first metal frame, and the metal frame 54 corresponds to an example of a second metal frame. Each of the metal frames 53 and 54 includes a titanium layer H51 and a germanium layer H52. The forming of the metal frames 53 and 54 includes forming the silicon oxide film G10 in the regions on the surface of the silicon substrate F10 where the sealing frames 43 and 44 are to be formed. The forming of the metal frames 53 and 54 further includes forming the titanium layer H51 on the silicon oxide film G10 and forming the germanium layer H52 on the titanium layer H51. The titanium layers H51 for the metal frames 53 and 54 are formed in the same step, and the germanium layers H52 for the metal frames 53 and 54 are formed in the same step. In the Z-axis direction, the thickness of the metal frame 53 is substantially equal to the thickness of the metal frame 54.

To prepare the upper cover 30, a composite substrate in which the silicon substrate Q10 and the glass substrate Q11 are combined is provided, and both surfaces of the composite substrate are polished.

Next, as illustrated in FIG. 4, metal frames 33 and 34, the spacer portion 45, and the contact portion 46 are formed thereon. According to an exemplary aspect, the metal frame 33 corresponds to an example of a third metal frame, and the metal frame 34 corresponds to an example of a fourth metal frame. The metal frame 33 and the spacer portion 45 each include the aluminum layer H31, the titanium layer H32, and the aluminum layer H33. The metal frame 34 includes the titanium layer H32 and the aluminum layer H33, and the contact portion 46 includes the aluminum layer H31. In the Z-axis direction, the thickness of the metal frame 33 is substantially equal to that of the spacer portion 45. In the Z-axis direction, the thickness of the metal frame 34 is smaller than that of the metal frame 33. In the Z-axis direction, the thickness of the contact portion 46 is smaller than that of the metal frame 34.

The forming of the metal frame 33 and the spacer portion 45 includes forming the aluminum layer H31 on the glass substrate Q11 in the regions where the sealing frame 43 and the spacer portion 45 are to be formed. The forming of the metal frame 33 further includes forming the titanium layer H32 on the aluminum layer H31 and forming the aluminum layer H33 on the titanium layer H32. The forming of the metal frame 34 includes forming the titanium layer H32 on the glass substrate Q11 in the region where the sealing frame 44 is to be formed and also includes forming the aluminum layer H33 on the titanium layer H32. The forming of the contact portion 46 includes forming the aluminum layer H31 on the silicon substrate Q10 in the region where the contact portion 46 is to be formed. The aluminum layer H31 for the metal frame 33, the spacer portion 45, and the contact portion 46 is formed in the same step. The titanium layer H32 for the metal frames 33 and 34 and the spacer portion 45 is formed in the same step. The aluminum layer H33 for the metal frames 33 and 34 and the spacer portion 45 is formed in the same step.

According to an exemplary aspect, the MEMS substrate 50 and the upper cover 30 are placed inside a chamber CH so as to face each other as illustrated in FIG. 4. When the MEMS substrate 50 and the upper cover 30 are placed so as to face each other, the gap between the metal frame 53 and the metal frame 33 is smaller than the gap between the metal frame 54 and the metal frame 34. The gap between the spacer portion 45 and the silicon substrate F10 is substantially equal to the gap between the contact portion 46 and the projection 13. In addition, the gap between the spacer portion 45 and the silicon substrate F10 is greater than the gap between the metal frame 53 and the metal frame 33 and is smaller than the gap between the metal frame 54 and the metal frame 34. To put it another way, when the MEMS substrate 50 and the upper cover 30 come closer to each other, the metal frame 53 and the metal frame 33 first come into contact with each other. Subsequently, the spacer portion 45 and the silicon substrate F10, and simultaneously the contact portion 46 and the projection 13, come into contact with each other. Finally, the metal frame 54 and the metal frame 34 come into contact with each other.

It is noted that insofar as the metal frame 53 and the metal frame 33 come into contact first, the thickness configuration of the metal frames is not limited to the above, in other words, not limited to that the thickness of the metal frame 53 is substantially equal to that of the metal frame 54 and the thickness of the metal frame 33 is greater than that of the metal frame 34. For example, the thickness of the metal frame 53 may be greater than that of the metal frame 54, and the thickness of the metal frame 33 may be greater than that of the metal frame 34. Alternatively, the thickness of the metal frame 53 may be greater than that of the metal frame 54, and the thickness of the metal frame 33 may be greater than that of the metal frame 34.

According to an exemplary aspect, the chamber CH is deaerated and filled with an inert gas GS. The degree of vacuum in the chamber CH is desirably about 0.1 atm or more and 10 atm or less, and more desirably about 0.5 atm or more and 5 atm or less. For example, the degree of vacuum is set to be 1 atm.

In the present embodiment, the spacer portion 45 is formed at the upper cover 30, but the formation of the spacer portion 45 is not limited to this configuration. According to an exemplary aspect, the spacer portion may be formed at the MEMS substrate or may be formed at both the MEMS substrate and the upper cover. Similarly, the contact portion may be formed at the MEMS substrate or may be formed at both the MEMS substrate and the upper cover.

Next, the first space (i.e., the movement spaces 28 and 48) is sealed (in step S20).

The sealing of the movement spaces 28 and 48 includes a eutectic reaction between the metal frame 53 and the metal frame 33. More specifically, the MEMS substrate 50 and the upper cover 30 are heated to a first temperature, and a first pressure is applied to the MEMS substrate 50 and the upper cover 30 in the direction of the MEMS substrate 50 and the upper cover 30 coming closer to each other. The first temperature is a temperature higher than the eutectic temperature of the Al-Ge-Ti-based eutectic alloy and lower than the melting point of aluminum. The first pressure is smaller than a pressure to deform the aluminum at the first temperature. Accordingly, when the MEMS substrate 50 and the upper cover 30 come closer to each other, the metal frame 53 and the metal frame 33 first come into contact with each other and are subjected to the eutectic reaction. According to an exemplary aspect, the movement spaces 28 and 48 are sealed at the degree of vacuum inside the chamber CH by forming the eutectic alloy H11.

As the eutectic reaction proceeds, the metal frame 53 and the metal frame 33 are transformed into the eutectic alloy H11, which allows the MEMS substrate 50 and the upper cover 30 to come even closer to each other. At this time, the spacer portion 45 comes into contact with the MEMS substrate 50, and the spacer portion 45 supports the MEMS substrate 50 and maintains the gap between the MEMS substrate 50 and the upper cover 30. When the spacer portion 45 is in contact with the MEMS substrate 50, a gap is created between the metal frame 54 and the metal frame 34.

Next, the degree of vacuum in the chamber CH is raised (in step S30).

More specifically, when the spacer portion 45 is in contact with the MEMS substrate 50 and the gap is created between the metal frame 54 and the metal frame 34, the degree of vacuum in the chamber CH is changed. The inert gas GS is drawn out of the chamber CH to raise the degree of vacuum. At this time, the degree of vacuum inside the chamber CH is desirably approximately 1 Pa or more and 100 Pa or less, and more desirably approximately 5 Pa or more and 50 Pa or less. For example, the degree of vacuum is set to about 10 Pa.

Next, the gap between the second metal frame (i.e., the metal frame 54) and the fourth metal frame (i.e., the metal frame 34) is closed (in step S40).

More specifically, the pressure acting so as to close the gap between the MEMS substrate 50 and the upper cover 30 is changed from the first pressure to a second pressure while maintaining the first temperature. According to an exemplary aspect, the second pressure is greater than the first pressure and is such that the aluminum deforms at the first temperature. As a result, the spacer portion 45 is smashed in the Z-axis direction to be flat, which allows the MEMS substrate 50 and the upper cover 30 to come even closer until the metal frame 54 comes into contact with the metal frame 34. It is noted that the MEMS substrate 50 and the upper cover 30 remain at the first temperature and the eutectic alloy H11 is in a molten state. As the MEMS substrate 50 and the upper cover 30 come even closer to each other, the thickness of the eutectic alloy H11 becomes smaller in the Z-axis direction and the eutectic alloy H11 is flattened along the XY plane.

Next, the second space (i.e., the movement spaces 29 and 49) is sealed (in step S50).

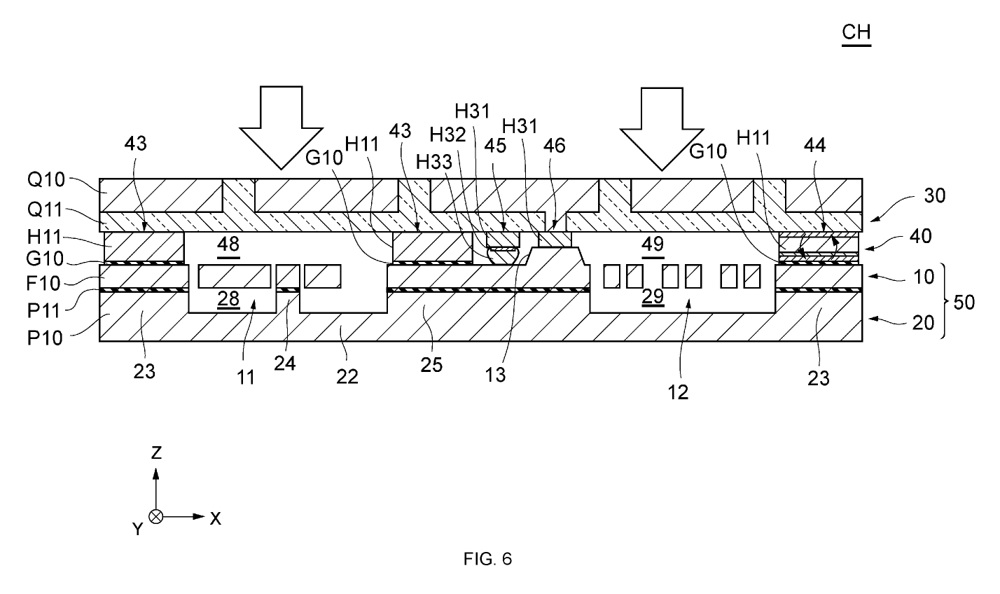

The sealing of the movement spaces 29 and 49 includes a eutectic reaction between the metal frame 54 and the metal frame 34. As illustrated in FIG. 6, when the metal frame 54 and the metal frame 34 come into contact with each other at the first temperature, which is higher than the eutectic temperature of the Al-Ge-Ti-based eutectic alloy, the eutectic reaction occurs between the metal frame 54 and the metal frame 34. The movement spaces 29 and 49 are sealed at the degree of vacuum inside the chamber CH by forming the eutectic alloy H12.

Finally, the composite sensor 1 is taken out of the chamber CH.

According to an exemplary embodiment of the present disclosure, as described above, the composite sensor 1 includes the MEMS substrate 50, the upper cover 30 opposing the MEMS substrate 50 with a gap interposed therebetween, the sealing frame 43 sealing the movement spaces 28 and 48, and the sealing frame 44 sealing the movement spaces 29 and 49. The acceleration sensor 11 is disposed in the movement spaces 28 and 48 and the angular velocity sensor 12 is disposed in the movement spaces 29 and 49. The degree of vacuum of the movement spaces 28 and 48 is lower than that of the movement spaces 29 and 49, and the sealing frames 43 and 44 are made of a eutectic alloy.

With this configuration, the acceleration sensor 11 and the angular velocity sensor 12 are formed in the same MEMS substrate 50, which suppresses the occurrence of the axial deviation between these sensors and thereby opens the way for producing a high-performance composite sensor 1. The two movement spaces can be sealed by the MEMS substrate 50, the upper cover 30, and the sealing frames 43 and 44 without forming through-holes or bumps to be used for adjusting the degree of vacuum in the two movement spaces. This configuration and process simplifies the manufacturing process of the product. In addition, this can reduce the number of potential leakage pathways, thereby improving the reliability of the product. The MEMS substrate 50 and the upper cover 30 are bonded by the eutectic alloy, and accordingly the bonding surface portion can be made of non-alkali glass. Using the non-alkali glass prevents the migration of alkali ions and thereby suppresses the change of the product characteristics caused by the alkali ions, which improves the reliability of the product, compared with the case of using alkali glass.

It is noted that the angular velocity sensor 12 may be formed in the movement spaces 28 and 48, and the acceleration sensor 11 may be formed in the movement spaces 29 and 49. In such a case, the degree of vacuum of the movement spaces 28 and 48 is higher than that of the movement spaces 29 and 49.

According to another embodiment, the composite sensor 1 further includes the spacer portion 45 disposed between the MEMS substrate 50 and the upper cover 30, and the spacer portion 45 includes a metal layer made of metals forming the eutectic alloy of the sealing frames 43 and 44.

With this configuration, the spacer portion 45 functions as a support for maintaining the gap between the MEMS substrate 50 and the upper cover 30, which reduces the occurrence of the gap changing undesirably between the MEMS substrate 50 and the upper cover 30 during the manufacturing process. Accordingly, the degree of vacuum of the movement spaces 28 and 48 and the degree of vacuum of the movement spaces 29 and 49 can be set appropriately, which improves the reliability of the product. The spacer portion 45 can be formed together in the forming of the sealing frames 43 and 44. Accordingly, the spacer portion 45 can be provided without increasing the number of manufacturing steps.

According to another exemplary embodiment, the method of manufacturing the composite sensor 1 includes providing the MEMS substrate 50 and the upper cover 30, sealing the movement spaces 28 and 48 by using the sealing frame 43, and sealing the movement spaces 29 and 49 by using the sealing frame 44. In the method of manufacturing the composite sensor 1, the acceleration sensor 11 is formed in the movement spaces 28 and 48 and the angular velocity sensor 12 is formed in the movement spaces 29 and 49. The degree of vacuum of the movement spaces 28 and 48 is lower than the degree of vacuum of the movement spaces 29 and 49, and the sealing frames 43 and 44 are made of the eutectic alloy.

With this configuration, the acceleration sensor 11 and the angular velocity sensor 12 are formed in the single MEMS substrate 50, which suppresses the occurrence of the axial deviation between these sensors and thereby open the way for producing a high-performance composite sensor 1. The two movement spaces can be sealed by the MEMS substrate 50, the upper cover 30, and the sealing frames 43 and 44. Accordingly, the method of manufacturing the composite sensor 1 does not include steps of forming through-holes or bumps to be used for adjusting the degree of vacuum in the two movement spaces. This simplifies the manufacturing process of the product. In addition, this process and configuration reduces the number of potential leakage pathways, thereby improving the reliability of the product. The MEMS substrate 50 and the upper cover 30 are bonded by the eutectic alloy, and accordingly the bonding surface portion can be made of non-alkali glass. Using the non-alkali glass prevents the migration of alkali ions and thereby suppresses the change of the product characteristics caused by the alkali ions, which improves the reliability of the product, compared with the case of using alkali glass.

According to another embodiment, in the method of manufacturing the composite sensor 1, the providing the MEMS substrate 50 includes forming the metal frames 53 and 54 on the surface thereof that opposes the upper cover 30, and the providing the upper cover 30 includes forming the metal frames 33 and 34 on a surface thereof that opposes the MEMS substrate 50. In addition, the sealing the movement spaces 28 and 48 by using the sealing frame 43 includes causing a eutectic reaction between the metal frame 53 and the metal frame 33, and the sealing the movement spaces 29 and 49 by using the sealing frame 44 includes causing a eutectic reaction between the metal frame 54 and the metal frame 34. Moreover, the providing the upper cover 30 further includes forming the spacer portion 45 on the surface thereof that opposes the MEMS substrate 50. The method of manufacturing the composite sensor 1 further includes raising the degree of vacuum in the chamber CH in a state in which the spacer portion 45 is in contact with the MEMS substrate 50 and a gap is formed between the metal frame 54 and the metal frame 34, the changing the degree of vacuum being implemented after the sealing the movement spaces 28 and 48 by using the sealing frame 43 and before the sealing movement spaces 29 and 49 by using the sealing frame 44. Note that the layer structure of the spacer portion 45 is the same as that of the metal frame 33.

With this configuration, the spacer portion 45 is configured as a support for maintaining the gap between the MEMS substrate 50 and the upper cover 30, which prevents the gap from changing undesirably between the MEMS substrate 50 and the upper cover 30. Accordingly, the degree of vacuum of the movement spaces 28 and 48 and the degree of vacuum of the movement spaces 29 and 49 can be set appropriately, which improves the reliability of the product. According to an exemplary aspect, the spacer portion 45 can be formed together in the forming of the metal frame 33. Accordingly, the spacer portion 45 can be provided without increasing the number of manufacturing steps.

Other embodiments are described as below. It is noted that the same or similar elements as those described in the first exemplary embodiment are denoted by the same or similar reference signs, and the description thereof will be omitted as appropriate. In addition, similar advantageous effects provided by similar features will not be repeated.

### Second Exemplary Embodiment

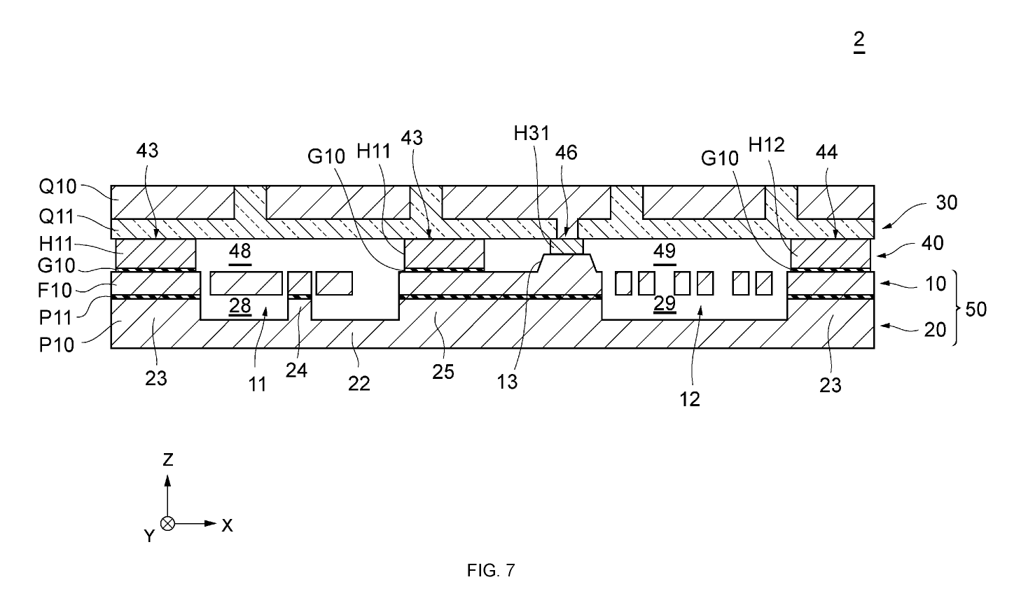

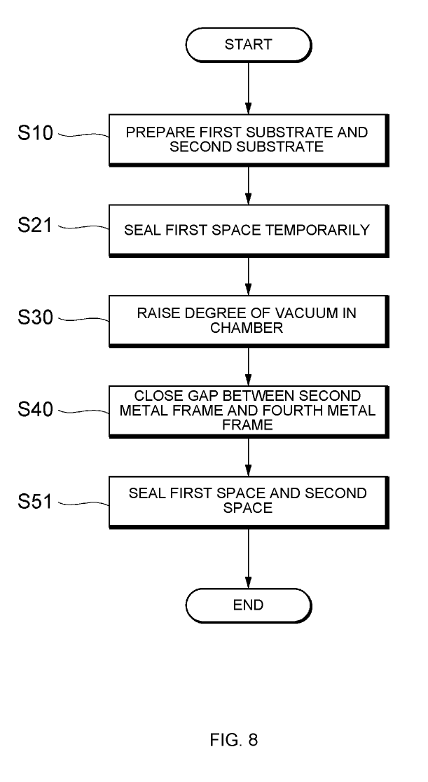

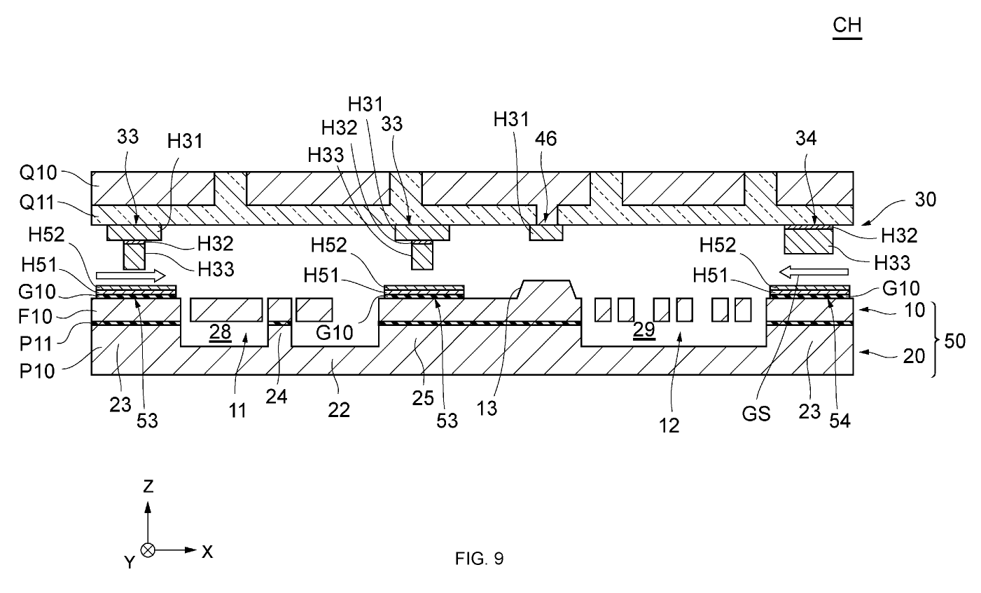

Next, the structure of a composite sensor 2 and a method of manufacturing the composite sensor 2 according to a second embodiment of the present disclosure is described with reference to FIGS. 7 to 11. FIG. 7 is a cross-sectional view illustrating the composite sensor of the second embodiment. FIG. 8 is a flowchart illustrating the method of manufacturing the composite sensor of the second exemplary embodiment. FIGS. 9 to 11 are cross-sectional views illustrating steps of manufacturing the composite sensor of the second exemplary embodiment.

As illustrated in FIG. 7, the composite sensor 2 does not include the spacer portion 45, which is different from the composite sensor 1. As illustrated in FIG. 8, the method of manufacturing the composite sensor 2 includes step S21 in which the first space is sealed temporarily, and step S21 replaces step S20 in which the first space is sealed. The method of manufacturing the composite sensor 2 also includes step S51 in which the first space and the second space are sealed, and step S51 replaces step S50 in which the second space is sealed.

FIG. 9 illustrates step S10 in which the first substrate (i.e., the MEMS substrate 50) and the second substrate (i.e., the upper cover 30) are prepared. As illustrated, the spacer portion 45 is not formed at the upper cover 30.

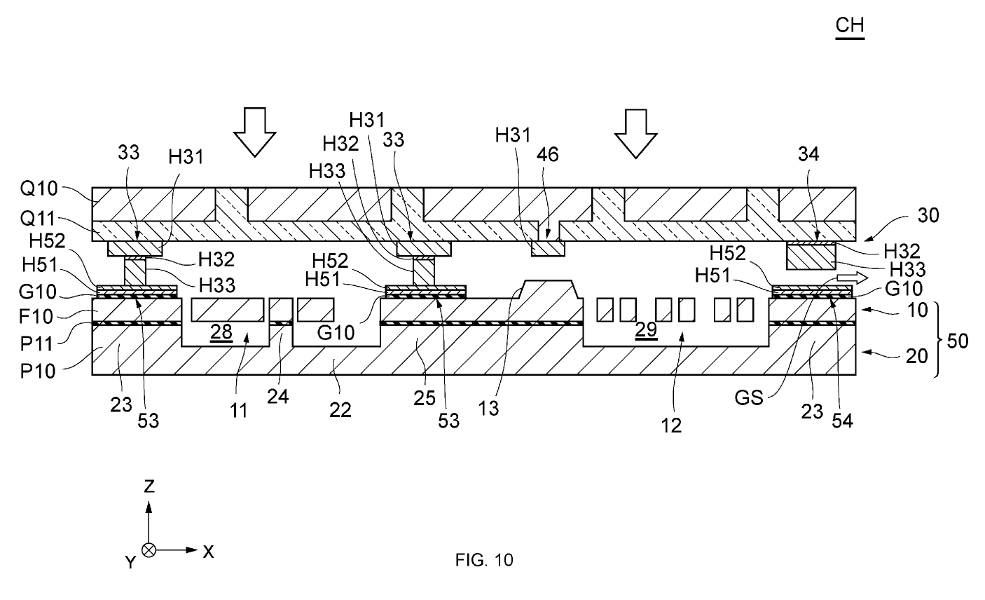

As illustrated in FIG. 10, in step S21 in which the first space (i.e., the movement spaces 28 and 48) is sealed temporarily, the MEMS substrate 50 and the upper cover 30 are heated to a second temperature and are pressed at the second pressure in a direction in which the MEMS substrate 50 and the upper cover 30 come closer to each other. The second temperature is a temperature higher than the eutectic temperature of the Al-Ge-Ti-based eutectic alloy and lower than the melting point of aluminum. The second pressure is a pressure at which the metal frame 53 and the metal frame 33 come into gas-tight contact with each other at the second temperature. One of the metal frame 53 and the metal frame 33 sinks into the other at the second pressure, which causes the metal frame 53 and the metal frame 33 to function as a metal gasket. The state of sealing made by the metal frame 53 and the metal frame 33 that are in contact with each other but are not subjected to the eutectic reaction is referred to as a “temporary sealing”. In this state, the metal frame 33 and the metal frame 53 function as a spacer for maintaining the gap between the metal frame 54 and the metal frame 34. In this state, step S30 for raising the degree of vacuum in the chamber CH is carried out.

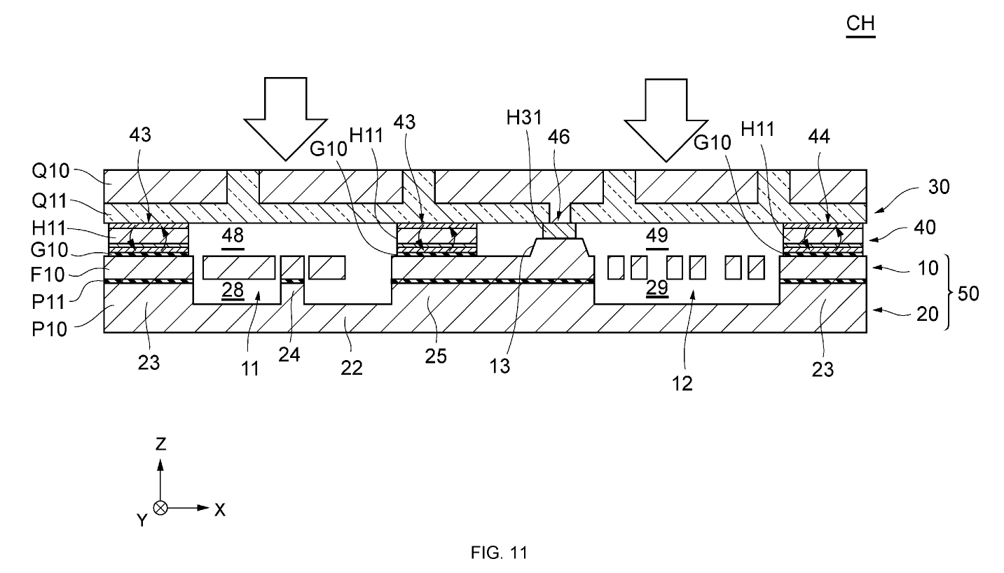

As illustrated in FIG. 11, in step S51 in which the first space (i.e., the movement spaces 28 and 48) and the second space (i.e., the movement spaces 29 and 49) are sealed, the MEMS substrate 50 and the upper cover 30 are heated to the first temperature. The eutectic reaction proceeds between the metal frame 53 and the metal frame 33, which are already in contact with each other, to form the eutectic alloy H11 in the molten state. The metal frame 53 and the metal frame 33 cease to function as the spacer. The MEMS substrate 50 and the upper cover 30 come even closer to each other, thereby bringing the metal frame 54 and the metal frame 34 into contact with each other and triggering another eutectic reaction to form the eutectic alloy H12.

### Third Exemplary Embodiment

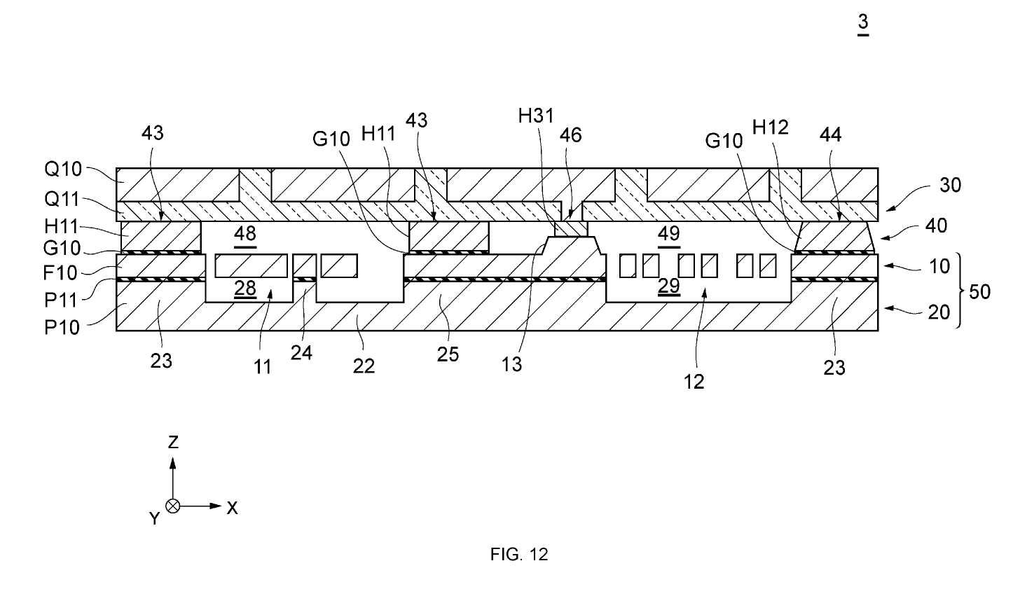

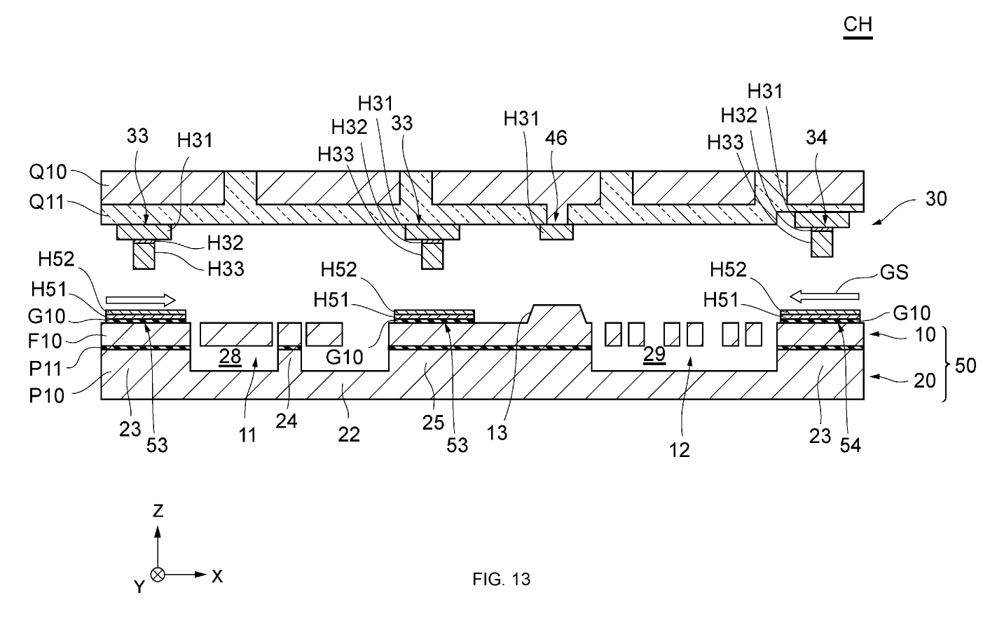

Next, the structure of a composite sensor 3 and a method of manufacturing the composite sensor 3 according to a third exemplary embodiment is described with reference to FIGS. 12 to 15. FIG. 12 is a cross-sectional view illustrating the composite sensor of the third exemplary embodiment. FIGS. 13 to 15 are cross-sectional views illustrating steps of manufacturing the composite sensor of the third exemplary embodiment.

As illustrated in FIG. 12, in the composite sensor 3, a step portion is formed at the surface of the upper cover 30 that faces the MEMS substrate 50, and the thickness of the sealing frame 43 is smaller than that of the sealing frame 44.

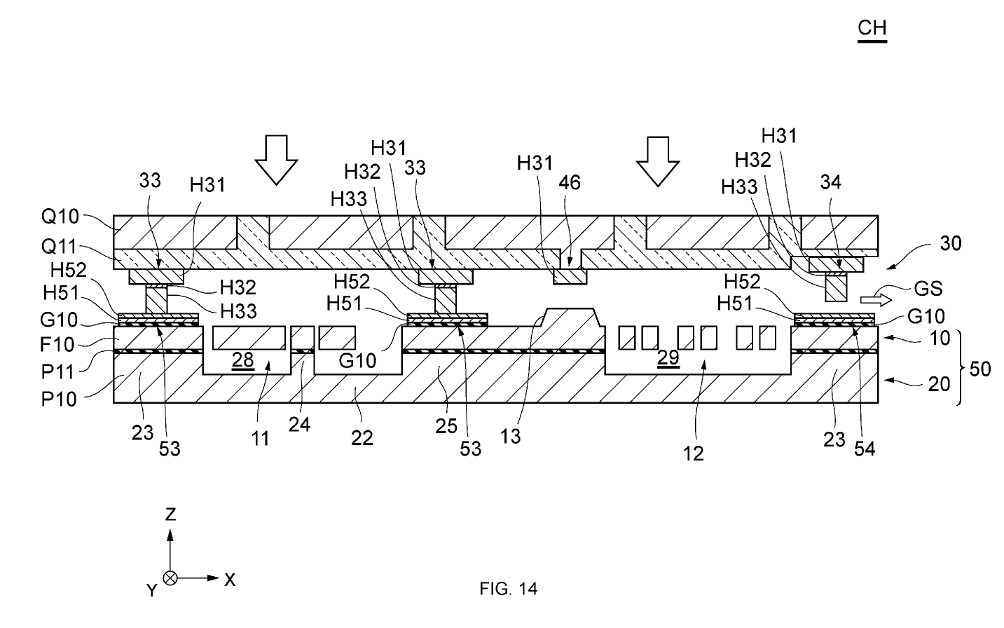

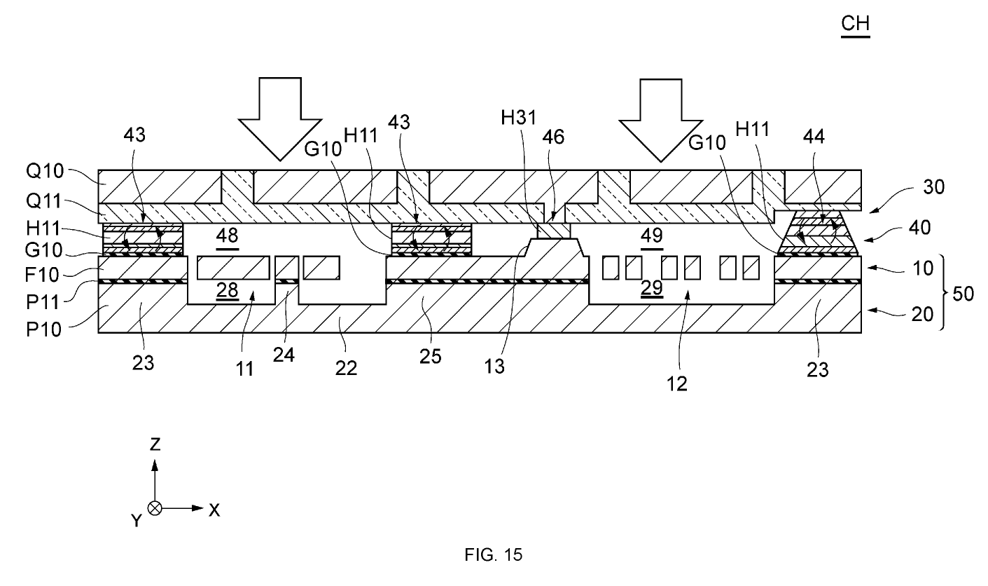

As illustrated in FIG. 13, the preparing of the upper cover 30 includes forming a step portion between the region where the metal frame 33 is formed and the region where the metal frame 34 is formed. More specifically, the region where the metal frame 34 is formed is recessed during the removal processing of the glass substrate Q11 of the upper cover 30. As a result, when the metal frame 53 and the metal frame 33 come into contact with each other as illustrated in FIG. 14, a gap is created between the metal frame 54 and the metal frame 34 even though the height of the metal frame 33 is substantially equal to that of the metal frame 34. As is the case for the method of manufacturing the composite sensor 2 of the second exemplary embodiment, step S51 for sealing the first space (i.e., the movement spaces 28 and 48) and the second space (i.e., the movement spaces 29 and 49) is carried out as illustrated in FIG. 15 to form the sealing frame 43 and the sealing frame 44 that is thicker than the sealing frame 43.

It is noted that although the step portion is provided at the upper cover 30 in the present embodiment, the step portion may be provided at the MEMS substrate 50 or may be provided both at the MEMS substrate 50 and at the upper cover 30.

### Fourth Exemplary Embodiment

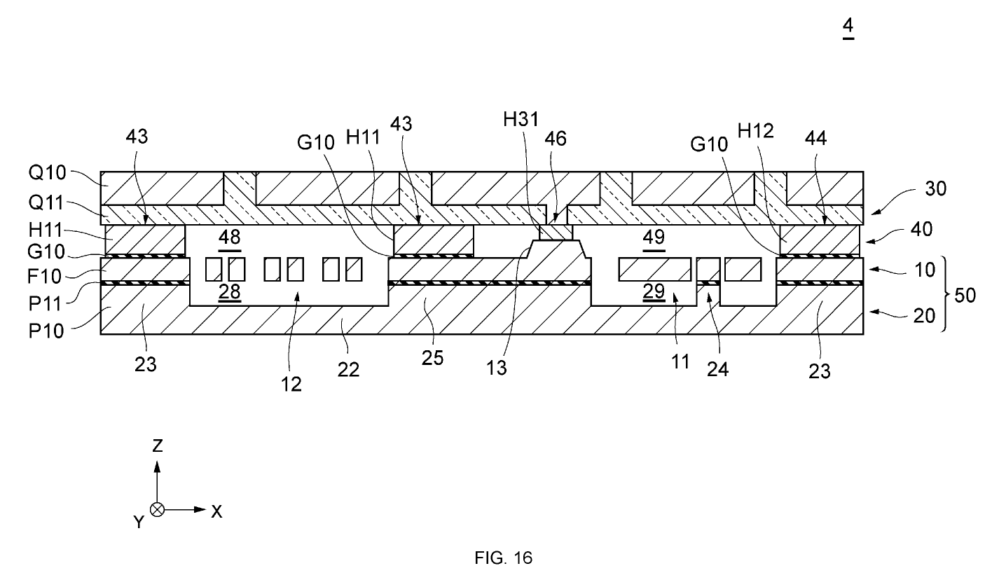

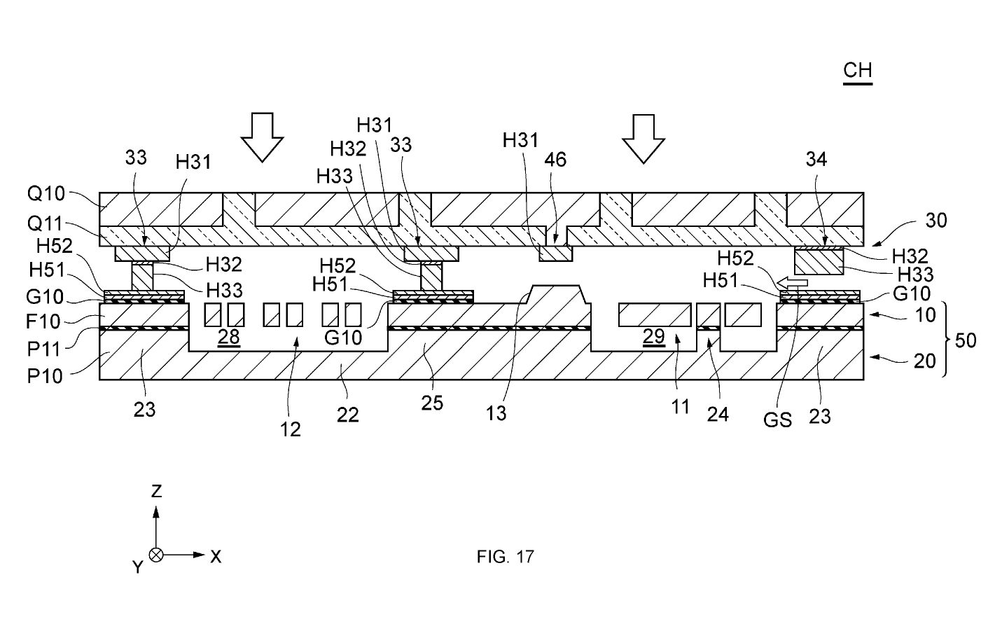

Next, the structure of a composite sensor 4 and a method of manufacturing the composite sensor according to a fourth exemplary embodiment is described with reference to FIGS. 16 to 17. FIG. 16 is a cross-sectional view illustrating the composite sensor of the fourth exemplary embodiment. FIG. 17 is a cross-sectional view illustrating a step of manufacturing the composite sensor of the fourth exemplary embodiment.

As illustrated in FIG. 16, in a composite sensor 4, the angular velocity sensor 12 is sealed in the movement spaces 28 and 48, and the acceleration sensor 11 is sealed in the movement spaces 29 and 49. The degree of vacuum in the movement spaces 28 and 48 is higher than that in the movement spaces 29 and 49.

As illustrated in FIG. 17, while keeping the high vacuum in the chamber CH, the movement spaces 28 and 48 are sealed temporarily and a gap is created between the metal frame 54 and the metal frame 34. In this state, the degree of vacuum of the chamber CH is lowered. Next, the movement spaces 28 and 48 and the movement spaces 29 and 49 are sealed.

It is noted that the present embodiment is different from the second exemplary embodiment in that the sensor sealed in the first space and the sensor sealed in the second space are replaced with each other and the step of lowering the degree of vacuum is carried out after the temporary sealing. These variations can be applied not only to the second embodiment but also to the first embodiment and to the third embodiment.

### Fifth Exemplary Embodiment

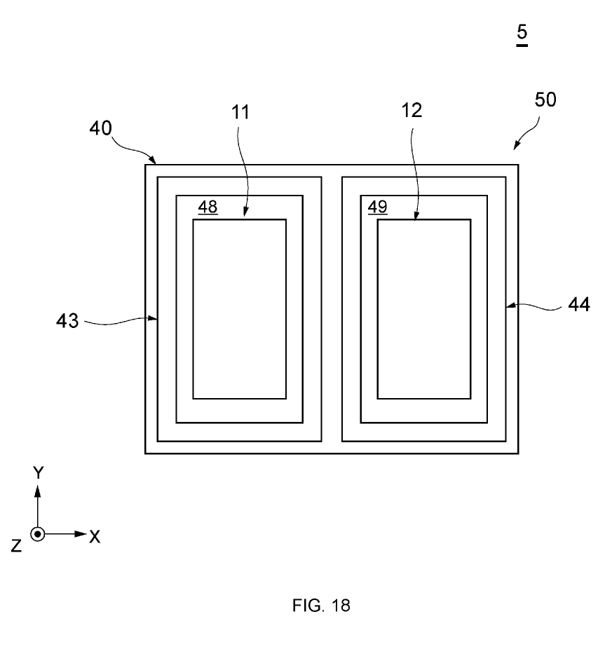

Next, the structure of a composite sensor 5 according to a fifth exemplary embodiment is described with reference to FIG. 18. FIG. 18 is a plan view illustrating the composite sensor of the fifth exemplary embodiment.

As illustrated in FIG. 18, the sealing frame 43 and the sealing frame 44 are arranged side by side with a gap formed therebetween as viewed in plan.

### Sixth Exemplary Embodiment

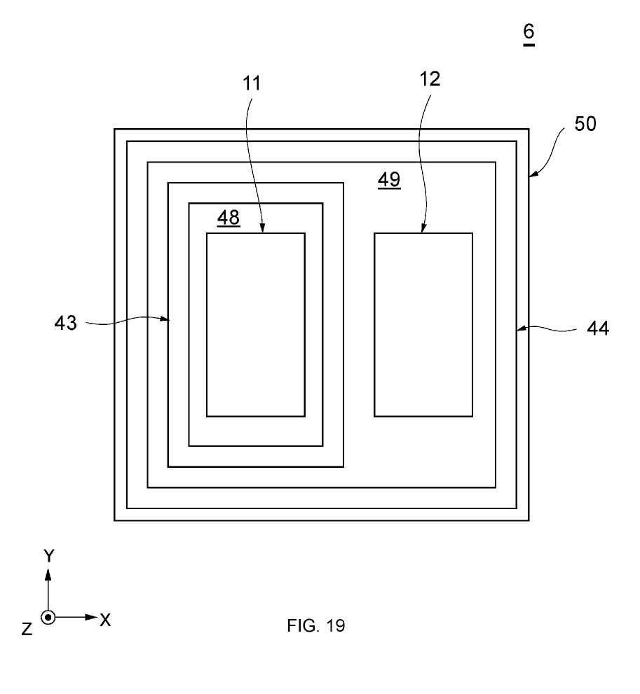

Next, the structure of a composite sensor 6 according to a sixth exemplary embodiment is described with reference to FIG. 19. FIG. 19 is a plan view illustrating the composite sensor of the sixth exemplary embodiment.

As illustrated in FIG. 19, the sealing frame 43 is surrounded by the sealing frame 44 as viewed in plan. The first space is formed inside the sealing frame 43, and the second space is formed outside the sealing frame 43 and inside the sealing frame 44.

According to the exemplary embodiments of the present disclosure, as described above, a reliable composite sensor is provided having a less complicated manufacturing process and a method of manufacturing the composite sensor is also provided.

It is noted that the above-described embodiments are provided to facilitate understanding of the exemplary aspects of the present disclosure and are not intended to limit the present invention. The exemplary aspects may be modified/improved without departing from the spirit thereof, and the present invention includes equivalents thereof. In other words, the embodiments may be subjected to design changes by a person skilled in the art, but such modifications fall within the scope of the present invention insofar as the modifications have characteristic features of the present invention. For example, the elements and their arrangements, materials, conditions, shapes, sizes, etc., of the embodiments are not limited to those described herein by way of example but may be modified as appropriate. In addition, the configurations described in the exemplary embodiment can be partially replaced or combined with one another if technically feasible, and such replacement or combination is included within the scope of the present disclosure insofar as such replacement or combination incorporates features of the present invention.

### REFERENCE SIGNS LIST

1 composite sensor

10 device layer

11 acceleration sensor

12 angular velocity sensor

20 lower cover

28, 29 movement space

30 upper cover

33, 34 metal frame

40 bonding layer

48, 49 movement space

43, 44 sealing frame

45 spacer portion

46 contact portion

50 MEMS substrate

53, 54 metal frame

P10, Q10, F10 silicon substrate

P11, G10 silicon oxide film

Q11 glass substrate

H11, H12 eutectic alloy

H31, H33 aluminum layer

H32, H51 titanium layer

H52 germanium layer

GS inert gas

1. A composite sensor comprising:
a first substrate;
a second substrate that opposes the first substrate with a gap interposed therebetween;
a first sealing frame comprising a eutectic alloy and configured to seal a first space between the first substrate and the second substrate;
a second sealing frame comprising a eutectic alloy and configured to seal a second space between the first substrate and the second substrate;
an acceleration sensor disposed in the first space; and
an angular velocity sensor disposed in the second space,
wherein a degree of vacuum of the first space is different from a degree of vacuum of the second space.

2. The composite sensor according to claim 1, wherein a composition of the eutectic alloy of the first sealing frame is different from a composition of the eutectic alloy of the second sealing frame.

3. The composite sensor according to claim 2, wherein:
the eutectic alloy of the first sealing frame and the eutectic alloy of the second sealing frame each comprise aluminum, and
a content of aluminum in the eutectic alloy of the first sealing frame is smaller than a content of aluminum in the eutectic alloy of the second sealing frame.

4. The composite sensor according to claim 1, wherein the first sealing frame comprises a thickness that is different from a thickness of the second sealing frame.

5. The composite sensor according to claim 1, wherein metals of the eutectic alloy of the first sealing frame and the second sealing frame each include aluminum and germanium.

6. The composite sensor according to claim 5, wherein the metals of the eutectic alloy of the first sealing frame further include titanium.

7. The composite sensor according to claim 1, further comprising a spacer disposed between the first substrate and the second substrate, the spacer including a metal layer formed from metals of the eutectic alloys of the first sealing frame and the second sealing frame.

8. The composite sensor according to claim 1, wherein the first sealing frame is surrounded by the second sealing frame in a plan view of the first substrate.

9. The composite sensor according to claim 1, wherein the first sealing frame and the second sealing frame are arranged side by side with a gap interposed therebetween in a plan view of the first substrate.

10. The composite sensor according to claim 1, wherein the first sealing frame is connected to the second sealing frame in a plan view of the first substrate.

11. A method of manufacturing a composite sensor, the method comprising:
providing a first substrate and a second substrate that opposes the first substrate with a gap interposed therebetween;
forming a first sealing frame made of a eutectic alloy to seal a first space formed between the first substrate and the second substrate;
forming a second sealing frame made of a eutectic alloy to seal a second space formed between the first substrate and the second substrate; and
forming an acceleration sensor in the first space and an angular velocity sensor in the second space,
wherein a degree of vacuum of the first space is different from a degree of vacuum of the second space.

12. The method of manufacturing the composite sensor according to claim 11, wherein:
the providing of the first substrate includes forming a first metal frame and a second metal frame on a surface of the first substrate, the surface of the first substrate opposing the second substrate,
the providing of the second substrate includes forming a third metal frame and a fourth metal frame on a surface of the second substrate, the surface of the second substrate opposing the first substrate,
the forming of the first sealing frame includes causing a eutectic reaction between the first metal frame and the third metal frame, and
the forming of the second sealing frame includes causing a eutectic reaction between the second metal frame and the fourth metal frame.

13. The method of manufacturing the composite sensor according to claim 12, wherein the providing of the second substrate further includes forming a spacer on a surface thereof that opposes the first substrate.

14. The method of manufacturing the composite sensor according to claim 13, further comprising changing a degree of vacuum in a chamber accommodating the first substrate and the second substrate in a state in which the spacer is in contact with the first substrate and a gap is formed between the second metal frame and the fourth metal frame, the changing of the degree of vacuum being implemented after the sealing of the first space by forming the first sealing frame and before the sealing of the second space by forming the second sealing frame.

15. The method of manufacturing the composite sensor according to claim 14, wherein a layer structure of the spacer is a same layer structure as that of the third metal frame.

16. The method of manufacturing the composite sensor according to claim 12, further comprising:
sealing the first space temporarily by bringing the first metal frame and the third metal frame into contact with each other at a temperature lower than a eutectic temperature of the eutectic alloy; and
changing a degree of vacuum in the chamber accommodating the first substrate and the second substrate in a state in which the third metal frame is in contact with the first metal frame and a gap is formed between the second metal frame and the fourth metal frame, the changing of the degree of vacuum being implemented after the sealing of the first space temporarily and before the sealing of the second space by forming the second sealing frame.

17. The method of manufacturing the composite sensor according to claim 16, wherein a thickness of the third metal frame is greater than a thickness of the fourth metal frame.

18. The method of manufacturing the composite sensor according to claim 16, wherein the providing of the second substrate includes forming a step portion between a region in which the third metal frame is to be formed and a region in which the fourth metal frame is to be formed.

19. The method of manufacturing the composite sensor according to claim 12, wherein
the forming of the first metal frame and the second metal frame includes forming a germanium layer, and
the forming of the third metal frame and the fourth metal frame includes forming an aluminum layer.

20. The method of manufacturing the composite sensor according to claim 19, wherein:
the forming of the third metal frame further includes forming a titanium layer and a second aluminum layer, and
the forming of the fourth metal frame further includes forming a titanium layer.
